(19) United States
(12) Patent Application Publication
(10) Pub. No.: US 2019/0077036 A1
(43) Pub. Date: Mar. 14, 2019

(54) Polymer Sheet and Manufacturing Method and Use Thereof

(71) Applicant: HUBEI XIANGYUAN NEW MATERIAL TECHNOLOGY INC., Xiaogan (CN)

(72) Inventors: Kerui GUO, Xiaogan (CN); Qiong WEI, Xiaogan (CN)

(21) Appl. No.: 16/085,293

(22) PCT Filed: Jun. 2, 2017
(86) PCT No.: PCT/CN17/86958

§ 371 Date: Sep. 14, 2018

(30) Foreign Application Priority Data
Jun. 23, 2016 (CN) 201610471971.3

(51) Int. Cl. B26D 3/28; B65H 16/02; B65H 18/28

(52) U.S. Cl. CPC B26D 3/28; B32B 3/12; B65H 18/28; B65H 16/025

(57) ABSTRACT

The invention relates to the field of polymer materials and processing. Provided are a polymer sheet and a manufacturing method and a use thereof. The polymer sheet has a thickness less than its average hole diameter. The polymer sheet is in the form of a cellular board having through holes in the thickness direction, and has a through-hole ratio of 20%-60%, a thickness of 10-500 μm, and an average hole diameter of 10-500 μm. The manufacturing method comprises a roll material supplying step, a continuous cutting step and a rolling step. The continuous cutting step has a precision error of ±0.02 mm. The above method can be used to manufacture a material having a low density, high impact resistance, a high compression rate, and low compression set and capable of serving as a sealing and buffering material for an electronic device.

### CROSS-REFERENCE TO RELATED APPLICATION

The present application is a 371 U.S. National Phase of International application No. PCT/CN2017/086958, filed on Jun. 2, 2017, which claims the benefit/priority of Chinese patent application No. 201610471971.3, filed with the State Intellectual Property Office on Jun. 23, 2016 and entitled “Polymer Sheet and Manufacturing Method and Use Thereof”, the contents of which are incorporated herein by reference in their entirety.

### TECHNICAL FIELD

The present disclosure relates to the field of sealing and cushioning materials for electronic devices, and more specifically relates to a polymer sheet containing a through-pore structure for sealing and cushioning of an electronic device, and a manufacturing method and use thereof.

### BACKGROUND ART

In recent years, electronic devices such as smart phones, liquid crystal display televisions and tablet computers have been designed to be thinner and lighter, which requires using thinned and lightweight components. Such electronic devices also require using a thinned and lightweight sealing and cushioning material, for which a thin-layer sheet of 0.3 mm or less is desired. On the other hand, with the updating and upgrading of smart handheld electronic products and the growing size of display screens, there are increasing requirements for cushioning and protecting large-sized screens and electronic modules, and accordingly, there are increasing requirements for the sealing and cushioning materials.

At present, there are three major types of sealing and cushioning materials often used in the field of electronic device products: polyurethane foamed materials, such as PORON® series products manufactured by ROGERS & INOAC Corporation; polyolefin supercritical foamed materials, such as SCF series products manufactured by Nitto Denko Corporation; and polyolefin electron beam crosslinked foamed materials.

Among the above three major types of products, the polyurethane foamed material has relatively excellent properties, but has defects such as high density and being difficult for ultra-thin processing (its thickness cannot be less than 0.1 mm); the polyolefin supercritical foamed material is both light and soft, but has a larger compression set, which is unfavorable to long-term sealing and damping; and the polyolefin crosslinked foamed material also has very excellent properties, but has a larger density as an ultra-thin (less than 0.1 mm in thickness) product, and moreover, the polyolefin crosslinked foamed material is also unfavorable to packaging processing because the material is of a closed-pore structure and has a lower compression ratio.

In order to meet the needs for designing lightweight, ultra-thinned and impact-resistant electronic products, it is necessary to develop a sheet material with a low density, high compression ratio, and small compression set.

### SUMMARY OF THE DISCLOSURE

In view of the above defects or improvement requirements of the prior art, the present disclosure provides a polymer sheet containing a through-pore structure and a method of manufacturing the same. A first object thereof is to obtain, by ingeniously designing and processing a material in terms of the pore diameter and thickness, a polymer sheet with a small thickness, low density, impact resistance, high compression ratio and low compression set which meets the requirements for cushioning and protecting the current large-sized screens and electronic modules. A second object thereof is to provide a method for producing a polymer sheet as described above, which has high production efficiency and low production costs, and is suitable for mass industrial application.

In order to achieve the above-mentioned objects, according to an aspect of the present disclosure, a polymer sheet is provided, which has a thickness smaller than the average pore diameter the polymer sheet, and has through pores along its thickness direction, such that the polymer sheet is shown in a form of honeycomb in the thickness direction, and the polymer sheet has a through-pore ratio of 20% to 60%, a thickness of 10 μm to 500 μm, and an average pore diameter of 10 μm to 500 μm. Here, a through pore refers to a pore running through the thickness direction, and the through pore does not include a closed pore and an open pore. The through-pore ratio refers to a ratio of the number of through pores to the number of all pores obtained by collecting statistics using a scanning electron micrograph.

Further, the polymer sheet has an apparent density of 0.01 to 0.6 g/cm³.

Further, the polymer sheet has a compression ratio of 50% to 95% and a compression set of 0% to 80%.

Further, the polymer sheet has a compression ratio of 50% to 95%, has a compression set ≤40% after it has been compressed to 75% at 70° C. for 22 hours, and has a compression set ≤20% after it has been compressed to 75% at 23° C. for 22 hours. A polymer containing closed pores or fine through pores, when loaded with a compressive force, is subjected to a repulsive force from the gas inside its enclosed pores, and an increase in thickness due to the deformation and pushing of pore walls, and the compression ratio is thus limited. After the polymer containing closed pores and fine through pores is transformed into a single-layer material shown in a form of honeycomb in the thickness direction, the material no longer contains an enclosed structure, and the surface area of the pore walls becomes relatively small. In the case that a compressive force is applied, no repulsive force from a gas is generated, and the amount of increase in thickness due to the deformation of the pore walls is reduced, therefore the compression ratio is increased, and the corresponding compression deformation stress is also reduced.

Further, it further comprises an adhesive layer and/or a functional layer. The adhesive layer and/or the functional layer are formed on a surface of the body of the polymer sheet. The adhesive layer performs a function of bonding. The functional layer performs a function of barrier, electric conduction, heat conduction, reinforcement, bending resistance, stab resistance, impact resistance, abrasion resistance, or cold resistance.

According to a second aspect of the present disclosure, a polymer sheet is also provided, which is obtained by means of cutting a base material in such a manner that the cut polymer sheet has a thickness smaller than the average pore diameter of the polymer sheet. The polymer sheet has a thickness of 10 μm to 500 μm, being shown in a form of honeycomb in a thickness direction. The polymer sheet has through pores along the thickness direction in its structure. The polymer sheet has a through-pore ratio of 20% to 60%

Further, the base material is a roll of polymer foamed sheet.

In the above inventive concept, the polymer sheet has the characteristics as described above. Therefore, it can be suitably used as a member used in the case that various members or components are mounted (assembled) to a predetermined part. It is preferably used, for example, as a sealing and cushioning material for use in smartphones, liquid crystal display televisions, tablet computers, liquid crystal display screens, batteries, new energy vehicles, etc.

According to a third aspect of the present disclosure, a method for preparing a polymer sheet is also provided. The polymer sheet is in a form the polymer sheet in the thickness direction, and the thickness of a single polymer sheet is smaller than an average pore diameter of the polymer sheet, and the method for preparing the polymer sheet comprises the steps as follows.

An unwinding step, whereby a roll of polymer material having the same material as the polymer sheet is fed into a cutting device at a feeding speed of 0.1 m/min to 10 m/min; the roll of polymer material having a thickness of 0.1 mm to 5 mm.

A continuous cutting step, whereby the roll of polymer material is cut along a cross section perpendicular to the thickness direction of the roll of polymer material, and cut in a direction along the length direction of the roll of polymer material, to obtain a polymer sheet having a set thickness; a length and a width of the polymer sheet are the same as the length and the width of the roll of polymer material, and a thickness of the polymer sheet is smaller than that of the roll of polymer material; the thickness of the polymer sheet is smaller than an average pore diameter of the roll of polymer material; the precision error of the continuous cutting step is within ±20%.

A winding step, whereby the polymer sheet is wound into a roll of the polymer sheet at a winding tension of 0 N to 100 N; in the case that the winding tension is 0, it is a tension-free winding, which is suitable for a soft polymer: a material having a high through-pore ratio, and/or a polymer sheet having a thickness of less than 100 μm.

Further, the cutting device includes one or more of a belt peeling machine, a hot wire cutting machine, and a hacksaw cutting machine.

According to a fourth aspect of the present disclosure, further provided is use of the polymer sheet as described above as a sealing and cushioning material for electronic devices, the electronic devices including: a smartphone, a liquid crystal display television, a tablet computer, a liquid crystal display screen, a battery, and a new energy vehicle.

In general, the above technical solutions conceived by the present disclosure can achieve the following beneficial effects compared with the prior art:

The present disclosure provides a polymer sheet containing a through-pore structure, which has a thickness smaller than the average pore diameter of the polymer sheet. It has through pores along a thickness direction, such that the polymer sheet is shown in a form of honeycomb in the thickness direction. It has a through-pore ratio of 20% to 60% depending on different base materials. It has a thickness of 10 μm to 500 μm, and an average pore diameter of 10 μm to 500 μm. With such a structure, the polymer sheet has low density, good impact resistance, high compression ratio, and low compression set, and with such properties, the sheet is capable of meeting the needs for designing lightweight, ultra-thin and impact-resistant electronic products, and being used as a sealing and cushioning material for electronic devices.

The present disclosure provides a continuous cutting method for preparing a polymer sheet, comprising an unwinding step, a continuous cutting step, and a winding step. In the continuous cutting step, the cutting is performed by a cutter going along a cross section perpendicular to the thickness direction of the roll of polymer material and the cutting is carried out in the length direction of the roll of polymer material. Similar to a continuous sheet-splitting method, precise control is performed, and the thickness of the roll of polymer material, the feeding speed and the cutting precision are matched, and finally the winding tension is matched, which can ensure the stable conveying of the roll of polymer material, the stable discharging of the polymer sheet, and the precise positioning between the roll of polymer material and the polymer sheet, and can also ensure that the polymer sheet is not damaged by tensile stress. In the method of the present disclosure, stable and appropriate unwinding and winding tensions are provided to the roll of polymer material and the polymer sheet, to constitute a continuous processing production line, so that the synchronous clamping and conveying or discharging of the roll of polymer material and the polymer sheet can be achieved, the roll of polymer material can be continuously processed into a roll of polymer sheet, and moreover, one roll of polymer material can be processed into multiple rolls of polymer sheet. Such a continuous cutting method has high production efficiency and low production cost, and is suitable for mass industrial application.

### BRIEF DESCRIPTION OF DRAWINGS

FIG. 1 is a scanning electron microscope view showing the schematic structure of a surface of a polymer sheet containing a through-pore structure prepared in Example 4 of the present disclosure; and

FIG. 2 is a scanning electron microscope view showing the schematic structure of a surface of a polymer sheet containing a through-pore structure prepared in Example 5 of the present disclosure.

### DETAILED DESCRIPTION OF EMBODIMENTS

In order to make the objects, technical solutions and advantages of the present disclosure clearer, the present disclosure will be further described in details below with reference to the accompanying drawings and examples. It should be understood that the specific examples described herein are merely intended to explain the present disclosure and are not intended to limit the present disclosure. Furthermore, the technical features involved in the various embodiments of the present disclosure described below may be combined with each other as long as they do not conflict with each other.

A base material of the present disclosure is a polymer foamed material (or foam material) having a blind-pore structure and a through-pore structure, and the base material is made by precision mechanical reprocessing into an ultra-thin through-pore material or through-pore film or sheet with a thickness smaller than an average foamed pore diameter. With reasonable material selection and processing, such a polymer sheet containing a through-pore structure has the characteristics of low density, high compression ratio, low compression set, ultra-thinness and precision, and so on, and is suitable for the packaging, cushioning, and damping of lightweight and ultra-thin electronic products, and used as a base material for other functional materials.

The polymer sheet containing a through-pore structure of the present disclosure is a single-layer sheet shown in a form of honeycomb with its walls of pores connected; and it includes through pores, and the polymer sheet containing a through-pore structure has a through-pore ratio of 20% to 60%, a sheet thickness of 10 to 500 μm, and a sheet pore diameter ranging from 10 to 500 μm; specifically, the thickness of the sheet is smaller than its average pore diameter, and the sheet has an apparent density of 0.1 to 0.6 g/cm³, a compression ratio of 50% to 95%, and a compression set of 0% to 80%. It has a compression set ≤40% under compression at 70° C. (a compression set after it has been compressed to 75% at 70° C. for 22 hours), and has a compression set ≤20% under compression at 23° C. (a compression set after it has been compressed to 75% at 23° C. for 22 hours). Further preferably, it has a compression set ≤20% under compression at 70° C. (a compression set after it has been compressed to 75% at 70° C. for 22 hours), and has a compression set ≤4% under compression at 23° C. (a compression set after it has been compressed to 75% at 23° C. for 22 hours). This property can be reached under an optimal condition, which is achieved by the raw materials and the cutting process together.

The polymer sheet containing a through-pore structure of the present disclosure preferably has a through-pore ratio of 20% to 60%. If the through-pore ratio is too high, in the case that the polymer sheet is used as a sealing material, its sealing property, especially waterproofness, may be decreased. If the through-pore ratio is too low, the flexibility of the polymer sheet containing a through-pore structure may be decreased.

The polymer sheet containing a through-pore structure of the present disclosure preferably has a sheet thickness of 10 to 500 μm, and its thickness is smaller than the average pore diameter of the sheet so that it is ultra-thin. If its thickness is less than 10 μm, its impact resistance will be greatly reduced in particular at a thinner part due to uneven thickness; and if the thickness is more than 500 μm, its use at a narrow part is limited. The polymer sheet preferably has a thickness of 30 μm to 150 μm.

The polymer sheet containing a through-pore structure of the present disclosure preferably has a sheet pore diameter ranging from 10 to 500 μm. Dust resistance can be enhanced and the light-shielding property can be improved by setting the upper limit of the average foamed pore diameter of the polymer sheet to be 500 μm, and on the other hand, impact absorbability can be improved by setting the lower limit of the pore diameter range of the polymer sheet to be 10 μm.

The polymer sheet containing a through-pore structure of the present disclosure preferably has an apparent density of 0.01 to 0.6 g/cm³. If the density is less than 0.01 g/cm³, a problem occurs in strength. If the density is more than 0.6 g/cm³, the flexibility is decreased and the lightweight demand cannot be met.

The polymer sheet containing a through-pore structure of the present disclosure preferably has a compression ratio of 50% to 95%. If the compression ratio is small, in the case that the polymer sheet is used as a sealing material, its sealing property is decreased. If the compression ratio is large, the polymer sheet is incompressible.

The polymer sheet containing a through-pore structure of the present disclosure has a compression set of 0 to 80%, and further has a compression set ≤40% when tested under a condition where it has been compressed to 75% at 70° C. for 22 hours, and has a compression set ≤20% when tested under a condition where it has been compressed to 75% at 23° C. for 22 hours.

With the above comprehensive definition of structure and properties, the polymer sheet of the present disclosure has adequate dust resistance and cushioning property, and especially good dynamic dust resistance (dust resistance property in a dynamic environment). If the above-mentioned polymer sheet material is deformed due to an impact as it vibrates or falls down, its thickness can be rapidly regained to fill the clearance, therefore, the entering of foreign matters such as dust can be prevented.

The polymer sheet in the present disclosure may be formed only of a polymer sheet, or may be formed by stacking other layers, such as an adhesive layer or a functional layer, on the polymer sheet. It may have an adhesive layer or a functional layer on one or both surfaces thereof.

An adhesive for forming the above-mentioned adhesive layer, without particular limitation, may be, for example, suitably chosen from a group of known adhesives including: acrylic adhesives, rubber adhesives (natural rubber adhesives, synthetic rubber adhesives, etc.), organic silicone adhesives, polyester adhesives, polyurethane adhesives, polyamide adhesives, epoxy adhesives, vinyl alkyl ether adhesives, fluorine adhesives, etc. The adhesives may be used separately or in combination of two or more of them. It should be noted that the adhesives may be adhesives in any form, including emulsion adhesives, solvent adhesives, hot-melt adhesives, oligomer adhesives, solid adhesives, and the like.

In addition, examples of a method of applying an adhesive layer to at least one surface of a polymer sheet may include: a method of applying an adhesive to at least one surface of a stretched thermoplastic resin foamed sheet by using a coating machine such as an applicator, a method of spraying and applying an adhesive to at least one surface of the stretched thermoplastic resin foamed sheet by using a sprayer, and a method of applying an adhesive to at least one surface of the stretched thermoplastic resin foamed sheet by using bristles.

The functional layer may be a metal layer or various plastic films or the like, where the metal layer may be, for example, gold, silver, platinum, aluminum, iron, copper, magnesium, nickel, or the like, or may be plated with a non-metal such as silicon carbide, aluminum oxide, magnesium oxide and indium oxide, and the functional layer may be prepared by one of electroplating, electroless plating, evaporation plating, and sputter plating, or a combination of more than one thereof.

Examples of the plastic film may include polyethylene, polypropylene, polyethylene terephthalate, polyamide, polyvinyl chloride, polycarbonate, polyacrylonitrile, polyvinyl alcohol, polyvinylidene chloride, an ethylene-vinyl alcohol copolymer, and other plastic films.

The functional layer may have functions for imparting a gas barrier property, electrical conductivity, toughness, bending resistance, stab resistance, impact resistance, abrasion resistance, cold resistance, etc.

The polymer sheet of the present disclosure may be processed to have a desired shape, thickness, etc. For example, it may be processed into various shapes corresponding to the used means, device, housing, member, or the like.

The polymer sheet of the present disclosure has the characteristics as described above, and therefore can be suitably used as a member in the case that various members or components are mounted (assembled) to a predetermined part. The polymer sheet of the present disclosure can be suitably used, especially, in electric or electronic devices as a member in the case that components constituting the electric or electronic devices are mounted (assembled) to a predetermined part. That is, the polymer sheet of the present disclosure may be preferably used for electric or electronic devices, and the polymer sheet of the present disclosure may also be a foamed member for electric or electronic devices.

The various members or components that can be mounted (assembled) by using the above-mentioned foamed member are not particularly limited, and for example, may preferably include various members or components or the like in electric or electronic devices. Examples of such members or components for electric or electronic devices may include, for example, an image display member (display section) (especially a small image display member) mounted in an image display means such as a liquid crystal display, an electroluminescence display, a plasma display, an optical member or optical component such as a camera or a lens (particularly a small camera or lens) mounted in a mobile communication means which is a so called “mobile phone” or “mobile information terminal”, etc.

As a suitable specific use of the polymer sheet of the present disclosure, for example, it may be used around a display section of an LCD (Liquid Crystal Display) or the like for the purpose of dust resistance, light-shielding, cushioning, etc., or used between the display section and the housing (window) of the LCD (Liquid Crystal Display) or the like.

A polymer sheet or a roll of polymer material which forms the polymer sheet having a through-pore structure of the present disclosure is not particularly limited, its base is composed of a polymer or a natural polymer-based composite material; the polymer or the natural polymer-based composite material has a porous or microporous structure, and the polymer sheet or the roll of polymer material has an average pore diameter of 10 μm to 500 μm, preferably an average pore diameter of 30 μm to 150 μm.

In order to obtain the above-mentioned polymer sheet having a through-pore structure, a polymer is preferably used as a foamed material for the base and is not particularly limited. Examples thereof may include polyolefin resins such as low-density polyethylene, medium-density polyethylene, high-density polyethylene, linear low-density polyethylene, polypropylene, copolymer of ethylene and propylene, copolymer of ethylene or propylene and other α-olefin (e.g., butane-1, pentene-1, hexane-1, 4-methylpentene-1, or the like), and copolymer of ethylene and other alkenyl unsaturated monomer (the alkenyl unsaturated monomer, for example, may be vinyl acetate, an acrylic acid, acrylate, methacrylic acid, methacrylate, vinyl alcohol, or the like); styrene resins such as polystyrene and acrylonitrile-butadiene-styrene copolymer (ABS resins); polyamide resins such as 6-nylon, 66-nylon, and 12-nylon; polyamideimide; polyurethane; polyimide; polyetherimide; acrylic resins such as polymethyl methacrylate; polyvinyl chloride; polyvinyl fluoride; alkenyl aromatic resins; polyester resins such as polyethylene terephthalate and polybutylene terephthalate; polycarbonate such as bisphenol-A polycarbonate; polyacetal; and polyphenylene sulfide. The foaming polymeric resins may be used separately or in combination of two or more of them.

The above-mentioned foaming polymer may also contain a rubber ingredient and/or a thermoplastic elastomer ingredient. The above-mentioned rubber ingredient or thermoplastic elastomer ingredient is not particularly limited as long as it has rubber elasticity and can have a high foaming ratio. For example, examples thereof may include various thermoplastic elastomers, e.g., natural rubber or synthetic rubber such as natural rubber, polyisobutylene, polyisoprene, chloroprene, butyl rubber, and nitrile butyl rubber; olefin elastomers such as ethylene-propylene copolymer, ethylene-propylene-diene copolymer, ethylene-vinyl acetate copolymer, polybutene, and chlorinated polyethylene; styrene elastomers such as styrene-butadiene-styrene copolymer, styrene-isoprene-styrene copolymer and hydrogenated products thereof; polyester elastomers; polyamide elastomers; polyurethane elastomers. In addition, these rubber ingredients or thermoplastic elastomer ingredients may be used separately or in combination of two or more of them.

In order to obtain the above-mentioned polymer sheet having a through-pore structure, a natural polymer-based composite material is preferably used as a base material, such as protein, cellulose, and other bio-based porous materials, hydrogels, and aerogels. Such materials contain a structure with relatively uniformly distributed open-cells or closed-cells and are porous or microporous soft materials having an average pore diameter ranging from 10 μm to 500 μm.

It should be noted that, within a range not affecting physical properties of the polymer sheet, the polymer sheet may also contain any one or more of a foaming agent, a foaming regulator, a sensitizer, a crystal nucleating agent, a surfactant, a tension modifier, an anti-shrinkage agent, a flowability modifier, a rheological agent, a photothermal stabilizer, a flame retardant, a plasticizer, a lubricant, a pigment, a filler, an antistatic agent, an antioxidant, and a color masterbatch.

Next, a method for manufacturing the polymer sheet having a through-pore structure according to the present disclosure will be described. First, it is necessary to prepare a polymer sheet or a roll of polymer material, and all the raw materials are added to a high-speed mixer and an extrusion granulator for kneading and granulation, or heated and melted in a calender to obtain a polymer sheet or roll.

The polymer sheet may be crosslinked by a commonly used method as needed. Examples of the method may include: a method of irradiating a foamable thermoplastic polyethylene resin sheet with ionizing radiation such as an electron beam, an α-ray, a β-ray and a γ-ray; and a method of mixing organic peroxide in a foamable thermoplastic resin sheet in advance, and heating the obtained foamable thermoplastic resin sheet to decompose the organic peroxide. These crosslinking methods may be used in combination.

The method of foaming the polymer sheet is not particularly limited, and examples thereof may include the generally used methods such as a physical method and a chemical method. The physical method is a method in which bubbles are formed by dispersing a low-boiling liquid (foaming agent), such as chlorofluorocarbons or hydrocarbons, in a resin, followed by heating to volatilize the foaming agent. The chemical method is a method in which bubbles are formed by using a gas generated by thermal decomposition of a compound (foaming agent) added to a resin. Examples thereof may include, for example, a method of heating by hot air, a method of heating by infrared rays, a method using a salt bath, and a method using an oil bath, and the foaming methods may be used in combination.

In an example of the present disclosure, a method for preparing a polymer sheet containing through-pores comprises the following steps:

An unwinding step, whereby a roll of polymer material having the same material as the polymer sheet is fed into a cutting device at a feeding speed of 0.1 m/min to 10 m/min; the roll of polymer material has a thickness of 0.1 mm to 5 mm. The cutting device includes one or more of a belt peeling machine, a hot wire cutting machine, and a hacksaw cutting machine.

A continuous cutting step, according to the average pore diameter of the polymer raw material, cutting is performed by a cutter going along a cross section perpendicular to the thickness direction of the roll of polymer material and the cutting is carried out in the length direction of the roll of polymer material to obtain a polymer sheet having a set thickness; a length and a width of the polymer sheet are the same as the length and the width of the roll of polymer material, and a thickness of the polymer sheet is smaller than that of the roll of polymer material; the thickness of the polymer sheet is smaller than the average pore diameter of the roll of polymer material; the precision error of the continuous cutting step is within ±20%; the thickness of the polymer sheet is smaller than the average pore diameter of the polymer sheet; and the average pore diameter of the polymer sheet is the same as the average pore diameter of the roll of polymer material.

The minimum cutting thickness in the continuous cutting step is less than 0.1 mm, and the precision error of the continuous cutting step is within ±20%.

A winding step, whereby the polymer sheet is wound into a roll, and the winding tension is from 0 N to 100 N.

During the precision cutting, the cutting device used includes a blade-belt peeling machine, a hot wire cutting machine, and a hacksaw cutting machine or a combination thereof, and moreover, an unwinding means and a winding means are included. The unwinding means is configured to unroll a roll-shaped polymer sheet and continuously convey the same in a linear direction toward the winding means by a conveying means, and the winding means is configured to roll and wind the cut polymer sheet, which is an important part constituting a continuous processing production line as a stable and appropriate winding and unwinding tension system, and the winding means can achieve the synchronous clamping and conveying of the roll of a polymer sheet. The continuous cutting method of the present disclosure can achieve a minimum cutting layer thickness of less than 0.1 mm and a precision error within ±20%, and moreover, can ensure that the cut ultra-thin material with a through-pore structure is not damaged by tensile stress and can be continuously processed into a roll.

Generally, different winding manners are selected and used according to different material thickness and properties of the polymer sheet, and the magnitude of the winding tension directly affects the winding quality and yield of the product. If the tension is too large and the polymer sheet is wound too tightly, the polymer sheet is prone to wrinkles and is easily broken.

The matching of the winding tension and the feeding speed is related to the hardness of the roll of polymer material. By Shore hardness, if the hardness value is 10 to 80 (Shore C), the winding tension is 0 to 60 N, and the feeding speed is 0.1 m/min to 10 m/min; if the hardness value is 50 to 80 (Shore D), the winding tension is 40 to 80 N, and the feeding speed is 0.1 m/min to 8 m/min; and if the hardness value is 80 to 90 (Shore D), the winding tension is 50 to 100 N, and the feeding speed is 0.1 m/min to 5 m/min.

Considering comprehensively from multiple aspects of further improvements in high compression ratios and small compression sets of the polymer sheet while ensuring the low density and improving the cushioning property of the material, constituting a continuous processing production line, without damages from tensile stress, the roll of polymer material should have a hardness value of 10 to 80 (Shore C) or a hardness value of 50 to 80 (Shore D), a thickness of 0.1 to 5 mm, a winding tension of preferably 0 to 50 N, and a feeding speed of 0.1 m/min to 5 m/min.

A polymer sheet containing a through-pore structure according to the present disclosure is not limited in its planar size, and is preferably a continuous roll having a width ranging from 10 mm to 1500 mm and a length ranging from 10 mm to 1000 m. Such dimension has universal adaptability and can offer great efficiency and convenience to the continuous production processing.

A polymer sheet containing a through-pore structure provided in the present disclosure has the following advantages compared with the polymer sheet of the prior art: the polymer sheet, even in an extreme condition in which the thickness is compressed to about 10 μm, has low density, good impact resistance, high compression ratio, and low compression set.

In the method of the present disclosure, precision cutting is used, and moreover, a stable and appropriate winding and unwinding tension system is provided to constitute a continuous processing production line to achieve synchronous clamping and conveying of the polymer sheet, and can ensure the stable conveying of the roll of polymer material and the polymer sheet and the precise positioning between them, so that the polymer sheet is not damaged by tensile stress, and thus can be continuously processed into a roll. The drawback of low efficiency caused by the commonly-used manner of repeated cutting in the prior art is overcome.

The content of the present disclosure will be further described below in connection with examples, and compositions in the following examples are all expressed in parts by weight.

### EXAMPLE 1

A commercially available polyurethane rigid foamed base was selected, which had a thickness of 5 mm, a width of 500 mm, a length of 800 m, an average pore diameter of 500 μm, an apparent density of 0.7 g/cm³, a compression ratio of 30%, a compression set ≤50% at 70° C. (75% compression, 22 h), a compression set ≤30% at 23° C., and a hardness of (Shore D) 50.

A fifth step of cutting a first layer of the polyurethane rigid foamed base, whereby the polyurethane rigid foamed base as a raw material was placed on an unwinding means; and a blade-belt peeling machine, a winding means and the unwinding means were activated.

An unwinding step, whereby the polyurethane rigid foamed base was fed into the cutting device at a feeding speed of 0.1 m/min, where the polyurethane rigid foamed base had a thickness of 5 mm.

A continuous cutting step, according to the average pore diameter of the polymer raw material, whereby cutting is performed by a cutter going along a cross section perpendicular to the thickness direction of the roll of polymer material, and the cutting is carried out in the length direction of the roll of polymer material to obtain a polymer sheet having a set thickness; a length and a width of the polymer sheet were the same as the length and the width of the roll of polymer material, and a thickness of the polymer sheet was smaller than that of the roll of polymer material, the thickness of the polymer sheet was smaller than the average pore diameter of the roll of polymer material, the cutting thickness was controlled to be 500 μm, and the precision error of the continuous cutting step was within ±20%.

A winding step, whereby the winding tension was 100 N.

After the cutting of the whole roll of the raw material was completed, the machine was stopped, and the cut sheet was wound and arranged.

A sixth step, where it should be emphasized that in the process described in the fifth step, the sheet collected by the winding means can continue to be cut; that is to say, the fifth step can be repeated to obtain the sheet which has been cut twice, even three or four times and so on until the cutting operation cannot be continued, and the sheet collected by the winding means during the repetition of the cutting process is also a sheet having a through-pore structure according to the present disclosure.

In the present example, the polyurethane rigid foamed base was a roll of polymer material or referred to as a polymer sheet.

In the present example, the polymer sheet containing a through-pore structure had the following properties: a thickness of 500 μm, an average pore diameter of 500 μm, an apparent density of 0.6 g/cm³, a through-pore ratio of 20%, a compression ratio of 50%, a compression set ≤40% at 70° C. (75% compression, 22 h), a compression set ≤20% at 23° C., a width of 500 mm, and a length of 800 m.

### EXAMPLE 2

A commercially available foamed base made of natural rubber and butyl rubber was selected, which had a thickness of 3 mm, a width of 800 mm, a length of 800 m, a pore diameter ranging from 40 μm to 400 μm, an average pore diameter of 300 μm, an apparent density of 0.5 g/cm³, a compression ratio of 40%, a compression set ≤40% at 70° C. (75% compression, 22 h), a compression set ≤35% at 23° C., and a hardness of (Shore C) 45.

Cutting a first layer of the base: the base raw material was placed on an unwinding means; and a blade-belt peeling machine, a winding means and the unwinding means were activated.

An unwinding step, whereby a roll of polymer material having the same material as the polymer sheet was fed into the cutting device at a feeding speed of 10 m/min, where the roll of polymer material had a thickness of 3 mm.

In a continuous cutting step, according to the average pore diameter of the polymer raw material, whereby the roll of polymer material was cut, along a cross section perpendicular to the thickness direction of the roll of polymer material, into a polymer sheet having a set thickness, where the cutting direction was along the length direction of the roll of polymer material, a length and a width of the polymer sheet were the same as the length and the width of the roll of polymer material, and only the thickness of the polymer sheet was smaller than the thickness of the roll of polymer material; the thickness of the polymer sheet was smaller than the average pore diameter of the polymer sheet, the cutting thickness was controlled to be 250 μm, and the precision error of the continuous cutting step was within ±20%.

A winding step, whereby the winding tension was 50 N.

After the cutting of the whole roll of the raw material was completed, the machine was stopped, and the cut sheet was wound and arranged.

A sixth step, it should be emphasized that in the process described in the fifth step, the sheet collected by the winding means can continue to be cut; that is to say, the fifth step is repeated to obtain the sheet which has been cut twice or even three or four times and so on until the cutting operation cannot be continued, and the sheet collected by the winding means during the repetition of the cutting process is also a sheet having a through-pore structure according to the present patent application.

In the present example, the foamed base made of natural rubber and butyl rubber was a roll of polymer material or referred to as a polymer sheet.

In the present example, the polymer sheet containing a through-pore structure had the following properties: a thickness of 250 μm, a pore diameter ranging from 40 μm to 400 μm, an average pore diameter of 300 μm, an apparent density of 0.3 g/cm³, a through-pore ratio of 60%, a compression ratio of 70%, a compression set ≤30% at 70° C. (75% compression, 22 h), a compression set ≤10% at 23° C., a width of 1500 mm, and a length of 800 m.

### EXAMPLE 3

A commercially available foamed roll mainly composed of polycarbonate is selected, which had a thickness of 0.1 mm, a width of 1500 mm, a length of 1000 m, an average pore diameter of 10 μm, an apparent density of 0.04 g/cm³, a compression ratio of 60%, a compression set ≤30% at 70° C. (75% compression, 22 h), a compression set ≤20% at 23° C., and a hardness of (Shore C) 10.

A third step, cutting a first layer of the polycarbonate roll; the polycarbonate roll was placed on an unwinding means; and a hot wire cutting machine, a winding means and the unwinding means are activated.

An unwinding step, whereby a roll of polymer material having the same material as the polymer sheet was fed into the cutting device at a feeding speed of 5 m/min, where the roll of polymer material had a thickness of 0.1 mm.

A continuous cutting step, according to the average pore diameter of the polymer raw material, whereby the roll of polymer material was cut, along a cross section of the roll of polymer material, into a polymer sheet having a set thickness, where a length and a width of the polymer sheet were the same as the length and the width of the roll of polymer material and only the thickness of the polymer sheet was smaller than the thickness of the roll of polymer material; the thickness of the polymer sheet was smaller than the average pore diameter of the polymer sheet; the cutting thickness was controlled to be 10 μm, and the precision error of the continuous cutting step was within ±20%.

A winding step, whereby the winding tension was 0 N.

After the cutting of the whole roll of the raw material was completed, the machine was stopped, and the cut sheet was wound and arranged.

A fourth step, where it should be emphasized that in the process described in the third step, the sheet collected by the winding means can continue to be cut; that is to say, the third step is repeated to obtain the polymer sheet which has been cut twice, or even three or four or more times until the cutting operation cannot be continued, and the sheet collected by the winding means during the repetition of the cutting process is also a sheet having a through-pore structure according to the present disclosure for the application.

In the present example, the polymer sheet containing a through-pore structure has the following properties: a thickness of 10 μm, a width of 10 mm, a length of 1000 m, an average pore diameter of 10 μm, a through-pore ratio of 40%, an apparent density of 0.01 g/cm³, a compression ratio of 95%, a compression set ≤20% at 70° C. (75% compression, 22 h), and a compression set ≤4% at 23° C. (75% compression, 22 h).

In the cutting method of the present disclosure, a set of self-designed machines was used to provide a stable and appropriate winding and unwinding tension system to constitute a continuous processing production line, so as to ensure that the prepared ultra-thin material with a through-pore structure was not damaged by tensile stress, and the through-pore structure was not damaged while increasing the compression ratio of the polymer sheet, reducing the compression set of the polymer sheet and improving the cushioning property of the material, thereby ensuring the excellent properties of the polymer sheet.

### EXAMPLE 4

A first step, whereby 70 parts by weight of low-density polyethylene resin, 70 parts by weight of ethylene propylene diene methylene, 10 parts by weight of azodicarbonamide foaming agent, 3 parts by weight of talc powder, 2 parts by weight of zinc stearate, 2 parts by weight of polyethylene wax, and 2 parts by weight of antioxidant were added to an internal mixer for thorough internal mixing at a temperature of 130° C., and then discharged into a double-stage kneading granulator for kneading and granulation to prepare a foaming masterbatch, wherein the double-stage kneading granulator was operated at a temperature of 100° C.

A second step, whereby the prepared foaming masterbatch, an additional 60 parts by weight of low-density polyethylene resin, 60 parts by weight of ethylene-vinyl acetate copolymer, 2 parts by weight of polyethylene wax, 0.5 parts by weight of antioxidant, and 0.4 parts by weight of trimethylolpropane trimethacrylate were added to a high-speed mixer, mixed at a room temperature for 3 to 5 minutes, then discharged into a single-screw extruder and extruded into a sheet, where the single-screw extruder was operated at a temperature of 100° C.

A third step, whereby the extruded sheet was irradiated and crosslinked by an electron accelerator at an irradiation dose of 20 Mrad.

A fourth step, the irradiated and crosslinked sheet material was fed into a high-temperature foaming furnace for foaming, and the foaming furnace was at a temperature of 260° C. Up to this point, the preparation of a crosslinked polyethylene base was completed, and the crosslinked polyethylene base was a polymer sheet or a roll of polymer material.

The crosslinked polyethylene base had a thickness of 5 mm, a width of 500 mm, a length of 800 m, a pore diameter ranging from 10 μm to 500 μm, an average pore diameter of 260 μm, an apparent density of 0.1 g/cm³, a compression ratio of 30%, a compression set ≤50% at 70° C. (75% compression, 22 h), a compression set ≤30% at 23° C., and a hardness of (Shore C) 30.

A fifth step, cutting a first layer of the crosslinked polyethylene base: the crosslinked polyethylene base as a raw material was placed on an unwinding means; and a blade-belt peeling machine, a winding means and the unwinding means were activated.

An unwinding step, whereby the crosslinked polyethylene base was fed into the cutting device at a feeding speed of 0.1 m/min, where the crosslinked polyethylene base had a thickness of 5 mm.

A continuous cutting step, according to the average pore diameter of the polymer raw material, whereby cutting is performed by a cutter going along a cross section perpendicular to the thickness direction of the roll of polymer material, and cut in a direction along the length direction of the roll of polymer material, to obtain a polymer sheet having a set thickness, where a length and a width of the polymer sheet were the same as the length and the width of the roll of polymer material, and a thickness of the polymer sheet was smaller than that of the roll of polymer material; the thickness of the polymer sheet was smaller than the average pore diameter of the roll of polymer material; the cutting thickness was controlled to be 50 μm, and the precision error of the continuous cutting step was within ±20%.

A winding step, whereby the winding tension was 100 N.

After the cutting of the whole roll of the raw material was completed, the machine was stopped, and the cut sheet was wound and arranged.

A sixth step, it should be emphasized that in the process described in the fifth step, the sheet collected by the winding means can continue to be cut; that is to say, the fifth step is repeated to obtain the sheet which has been cut twice, or even three or four times and so on until the cutting operation cannot be continued, and the sheet collected by the winding means during the repetition of the cutting process is also a sheet having a through-pore structure according to the present disclosure.

In the present example, the crosslinked polyethylene base was a roll of polymer material or referred to as a polymer sheet.

In the present example, the polymer sheet containing a through-pore structure had the following properties: a thickness of 50 μm, a pore diameter ranging from 10 μm to 500 μm, an average pore diameter of 260 μm, an apparent density of 0.1 g/cm³, a through-pore ratio of 40%, a compression ratio of 90%, a compression set ≤20% at 70° C. (75% compression, 22 h), a compression set ≤10% at 23° C., a width of 500 mm, and a length of 800 m.

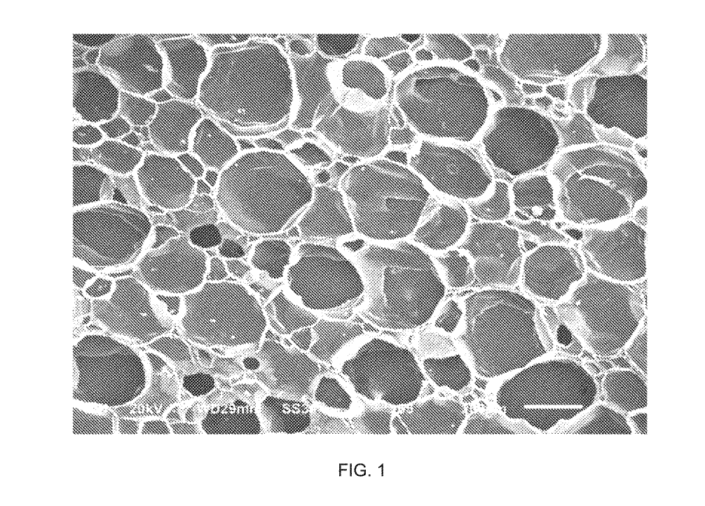

FIG. 1 is a scanning electron microscope view showing the schematic structure of a surface of a polymer sheet containing a through-pore structure prepared in Example 4 of the present disclosure. As can be seen from the figure, the schematic view includes two parts, a sample at a top layer and a carrier at a bottom layer. During a test using a scanning electron microscope, a carrier (which is mostly a conductive adhesive) is required to fix a sample to be tested onto a test platform for observation. Through pores express a darker color in the photo, and the material of the bottom carrier or an obvious sign of breakage in inner walls of the pores can be directly seen; open pores express a lighter color, it can be directly viewed that a diaphragm layer exists, and the continuity of inner walls of the pores is good without a sign of breakage. As is clear from the figure, the polymer sheet is shown in a form of honeycomb with its walls of pores connected.

### Example 5

A crosslinked polyethylene base was obtained by a method similar to that of Example 4, the crosslinked polyethylene base having a thickness of 0.5 mm, a width of 50 mm, a pore diameter ranging from 40 μm to 400 μm, an average pore diameter of 300 μm, an apparent density of 0.5 g/cm³, a compression ratio of 50%, a compression set ≤60% at 70° C. (75% compression, 22 h), a compression set ≤35% at 23° C., and a hardness of (Shore C) 10. The difference was that there were 15 parts by weight of an azodicarbonamide foaming agent, and the foaming furnace was at a temperature of 280° C.

Cutting a first layer of the crosslinked polyethylene base: the crosslinked polyethylene base as a raw material base was placed at an unwinding means; and a blade-belt peeling machine, a winding means and the unwinding means were activated.

An unwinding step, whereby a roll of polymer material having the same material as the polymer sheet was fed into the cutting device at a feeding speed of 0.2 m/min, where the roll of polymer material had a thickness of 0.5 mm.

In a continuous cutting step, according to the average pore diameter of the polymer raw material, whereby the roll of polymer material was cut, along a cross section perpendicular to the thickness direction of the roll of polymer material, into a polymer sheet having a set thickness where the cutting direction was along the length direction of the roll of polymer material; a length and a width of the polymer sheet were the same as the length and the width of the roll of polymer material and was smaller only in thickness than the roll of polymer material; the thickness of the polymer sheet was smaller than the average pore diameter of the polymer sheet, the cutting thickness was controlled to be 10 μm, and the precision error of the continuous cutting step was within ±20%.

A winding step, whereby the winding tension was 0 N.

After the cutting of the whole roll of the raw material was completed, the machine was stopped, and the cut sheet was wound and arranged.

A sixth step, it should be emphasized that in the process described in the fifth step, the sheet collected by the winding means can continue to be cut; that is to say, the fifth step is repeated to obtain the sheet which had been cut twice or even three or four times and so on until the cutting operation cannot be continued, and the sheet collected by the winding means during the repetition of the cutting process is also a sheet having a through-pore structure according to the present patent application.

In the present example, the crosslinked polyethylene base was a roll of polymer material or referred to as a polymer sheet.

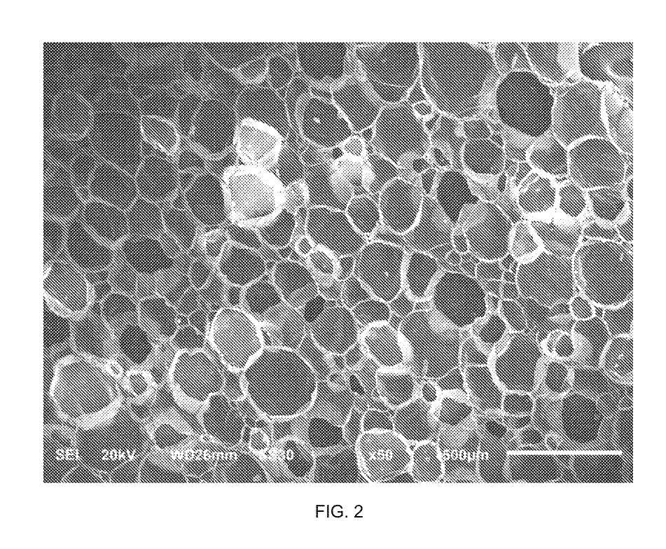

FIG. 2 is a scanning electron microscope schematic view showing the schematic structure of a surface of a polymer sheet containing a through-pore structure prepared in Example 5 of the present disclosure. As can be seen from the figure, the schematic view includes two parts, a sample at a top layer and a carrier at a bottom layer. The polymer sheet containing a through-pore structure had the following properties: a thickness of 10 μm, a pore diameter ranging from 40 μm to 400 μm, an average pore diameter of 300 μm, an apparent density of 0.5 g/cm³, a through-pore ratio of 60%, a compression ratio of 70%, a compression set ≤40% at 70° C. (75% compression, 22 h), and a compression set ≤20% at 23° C.

### EXAMPLE 6

A first step, whereby 50 parts by weight of isocyanate, 90 parts by weight of polyether polyol, 5 parts by weight of water, 2 parts by weight of a stabilizer, 0.05 parts by weight of triethylenediamine, which was a catalyst, and 15 parts by weight of a chain extender were taken. Raw materials (the raw materials including the polyether polyol, water, stabilizer, catalyst, and chain extender) were weighted at 5-15 percent, and the above weighted raw materials (including the polyether polyol, water, stabilizer, catalyst, and chain extender) were added to a stirrer with pressurizing and heating functions, and stirred sufficiently at a temperature of 70° C. for 30 minutes to form a mixture A.

A second step, the isocyanate and the mixture A were mixed by a known mechanical foaming method, injected into a mixing head, and stirred at a high speed to form a reactant B, and then the reactant B was applied onto a roll of PET by a coating method to obtain a polyurethane roll.

Up to this point, the preparation of the roll of polyurethane was completed. The roll of polyurethane had a thickness of 1 mm, a width of 1500 mm, a length of 1000 m, a pore diameter ranging from 100 μm to 300 μm, an average pore diameter of 150 μm, an apparent density of 0.1 g/cm³, a compression ratio of 90%, a compression set ≤10% at 70° C. (75% compression, 22 h), a compression set ≤5% at 23° C., and a hardness of (Shore C) 10.

A third step, cutting a first layer of the polyurethane roll: the polyurethane roll was placed on an unwinding means; and a hot wire cutting machine, a winding means and the unwinding means were activated.

An unwinding step, whereby a roll of polymer material having the same material as the polymer sheet was fed into the cutting device at a feeding speed of 5 m/min, where the roll of polymer material had a thickness of 1 mm.

A continuous cutting step, according to the average pore diameter of the polymer raw material, whereby the roll of polymer material was sliced, along a cross section of the roll of polymer material, into a polymer sheet having a set thickness, where a length and a width of the polymer sheet were the same as the length and the width of the roll of polymer material and only the thickness of the polymer sheet was smaller than the thickness of the roll of polymer material; the thickness of the polymer sheet was smaller than the average pore diameter of the polymer sheet, the cutting thickness was controlled to be 100 μm, and the precision error of the continuous cutting step was within ±20%.

A winding step, whereby the winding tension was 0 N.

After the cutting of the whole roll of the raw material was completed, the machine was stopped, and the cut sheet was wound and arranged.

A fourth step, it should be emphasized that in the process described in the third step, the sheet collected by the winding means can continue to be cut; that is to say, the third step is repeated to obtain the polymer sheet which has been cut twice, or even three or four or more times until the cutting operation cannot be continued, and the sheet collected by the winding means during the repetition of the cutting process is also a sheet having a through-pore structure according to the present disclosure for the application.

In the present example, the polymer sheet containing a through-pore structure had the following properties: a thickness of 100 μm, a width of 400 mm, a length of 1000 m, a pore diameter ranging from 100 μm to 300 μm, an average pore diameter of 150 μm, a through-pore ratio of 40%, an apparent density of 0.1 g/cm³, a compression ratio of 95%, a compression set ≤20% at 70° C. (75% compression, 22 h), and a compression set ≤4% at 23° C. (75% compression, 22 h).

In the cutting method of the present disclosure, a set of self-designed machines was used to provide a stable and appropriate winding and unwinding tension system to constitute a continuous processing production line, so as to ensure that the prepared ultra-thin material with a through-pore structure was not damaged by tensile stress, and the through-pore structure was not damaged while increasing the compression ratio of the polymer sheet, reducing the compression set of the polymer sheet and improving the cushioning property of the material, thereby ensuring the excellent properties of the polymer sheet.

In the present disclosure, related terms and related test methods are defined or performed as follows:

Test Methods:

Measurement of Through-Pore Ratio A sample is selected, and the number of through pores and the number of closed pores are counted in a selected area using a scanning electron microscope to calculate the through-pore ratio.

Measurement of Thickness:

The thickness of the polymer sheet containing a through-pore structure is measured based on the method described in GB/T6672-2001. A test sample is cut out along the entire width in the transverse direction at a distance of about 1 m from the longitudinal end of the sample. The test sample is 100 mm in width and 1000 mm in length. The thickness is measured at 20 parts of the sample using a thickness gauge, and an average thickness is the arithmetic mean of all the measurement values.

Measurement of Apparent Density:

The apparent density of the polymer sheet containing a through-pore structure is measured based on the method described in GB/T6343-2009. Five samples of 10000×10000 mm are taken in parallel along the transverse direction, and the average thickness and mass thereof are measured.

$${ρ}_{a} = \frac{m + {m}_{a}}{V} \times {10}^{6}$$

ρₐ—apparent density, in a unit of kilograms per cubic meter (kg/m³);
m—the mass of the test sample, in a unit of grams (g);
mₐ—the mass of the discharged air, in a unit of grams (g);
V—the volume of the test sample, in a unit of cubic millimeters (mm³).

Average Pore Diameter:

An enlarged image of the pore diameter of the polymer sheet is read by a digital microscope, the areas of all the cells which appear in a certain area (1 mm²) of the cut surface are measured and converted into equivalent circle diameters, and then data statistic-collecting is performed by the number of the cells, and thus an average pore diameter is obtained.

Compression Ratio:

A test sample is selected, and the maximum deformation at a pressure of 800 Kpa is measured to calculate a compression ratio.

Compression ratio (%)=[(P−M)/P]×100
P—the thickness of the test sample under an initial load, in a unit of millimeters (mm);
M—the thickness of the test sample under a total load, in a unit of millimeters (mm).

Compression Set:

The compression set of the polymer sheet containing a through-pore structure is measured based on the method described in GB/T6669-2008. A test sample of 50 mm in both length and width is selected, the test samples sufficient in number are stacked so that the stacked test sample has a total thickness of at least 25 mm before being compressed; the whole stacked test sample is used as a test sample, and there are 5 stacked test samples in total. An initial thickness d₀ is measured; the stacked test sample is compressed to 75%, within 15 minutes, the compressed stacked test sample is placed in an oven at 70° C. for 22 h, taken out and recovered to the laboratory temperature, and the final thickness dᵣ of the stacked test sample is measured. The compression set values (CS) are calculated, and an average value thereof is taken.

$$CS ( 75 \% , 22 h , 70 ° C . ) = \frac{{d}_{0} - {d}_{r}}{{d}_{0}} \times 100 \%$$

CS—compression set, expressed as a percentage (%);
d₀—the initial thickness of the test sample, in a unit of millimeters (mm);
dᵣ—the final thickness of the test sample, in a unit of millimeters (mm);

A compression set at 23 degrees Celsius is measured by the same standard as described above, and the difference is that the oven is at a temperature of 23° C.,

$$CS ( 75 \% , 22 h , 23 ° C . ) = \frac{{d}_{0} - {d}_{r}}{{d}_{0}} \times 100 \%$$

CS—compression set, expressed as a percentage (%);
d₀—the initial thickness of the test sample, in a unit of millimeters (mm);
dᵣ—the final thickness of the test sample, in a unit of millimeters (mm).

Shore Hardness:

The Shore hardness is tested using Shore C and Shore D durometers. The thickness of a test sample is at least 4 mm, and a desired thickness may be obtained by stacking several thinner layers. The size of the test sample should be large enough to ensure a measurement to be carried out at a distance of at least 9 mm from any edge, and the surface of the test sample is flat.

The test sample is placed on a hard, firm, and stable horizontal plane, and the durometer is held so that it is in a vertical position, and at the same time a top end of a needle indenter or a ball indenter is distanced by at least 9 mm from any edge of the test sample. The indenter base is immediately applied to the test sample without impact, so that the indenter base is parallel to the test sample and applied a sufficient pressure thereto. The indenter base should be brought into close contact with the test sample, and after (15±1)s, a value indicated by an indicating means is read. Five hardness values are measured on the same test sample at intervals of at least 6 mm, and an average value of the five hardness values was calculated.

In the case that the value indicated by the Shore C durometer is higher than 90, the measurement is performed by using a Shore D durometer instead.

The above description is only illustrative of preferred examples of the present disclosure, and is not intended to limit the present disclosure in any form. Although the present disclosure has been disclosed above in connection with the preferred examples, they are not intended to limit the present disclosure. Any of those skilled in the art can make equivalent examples with some equivalent variations or modifications by using the technical contents disclosed above without departing from the scope of the technical solutions of the present disclosure. Any simple variations, equivalent changes and modifications made to the above embodiments based on the technical essence of the present disclosure without departing from the technical solutions of the present disclosure should still fall within the scope of the technical solutions of the present disclosure.

1. A polymer sheet, wherein the polymer sheet has a thickness smaller than an average pore diameter of the polymer sheet, and has through pores along a thickness direction of the polymer sheet, such that the polymer sheet is in a form of honeycomb in the thickness direction, and the polymer sheet has a through-pore ratio of 20% to 60%, a thickness of 10 μm to 500 μm, and an average pore diameter of 10 μm to 500 μm.

2. The polymer sheet according to claim 1, wherein the polymer sheet has an apparent density of 0.01 to 0.6 g/cm3.

3. The polymer sheet according to claim 1, wherein the polymer sheet has a compression ratio of 50% to 95%.

4. The polymer sheet according to claim 1, further comprising at least one of an adhesive layer or a functional layer, wherein the at least one of the adhesive layer or the functional layer is formed on a surface of a body of the polymer sheet.

5. A polymer sheet, wherein the polymer sheet is obtained by cutting a base material in such a manner that the cut polymer sheet has a thickness smaller than an average pore diameter of the polymer sheet;
the polymer sheet has a thickness of 10 μm to 500 μm, and is shown in a form of honeycomb in a thickness direction, wherein the polymer sheet has, in structure, through-pores along the thickness direction, with a through-pore ratio of 20% to 60%.

6. The polymer sheet according to claim 5, wherein the base material is a roll of polymer foamed sheet.

7. A method for preparing a polymer sheet, wherein the polymer sheet is in a form of honeycomb in a thickness direction, and a thickness of each polymer sheet is smaller than an average pore diameter of the polymer sheet,
the method comprising following steps:
an unwinding step, wherein a roll of polymer material having same material as the polymer sheet is fed into a cutting device at a feeding speed of 0.1 m/min to 10 m/min, the roll of polymer material having a thickness of 0.1 mm to 5 mm;
a continuous cutting step, wherein cutting is performed by a cutter going along a cross section perpendicular to a thickness direction of the roll of polymer material, and the cutting is carried out in a length direction of the roll of polymer material, to obtain a polymer sheet having a set thickness, wherein a length and a width of the polymer sheet are the same as the length and width of the roll of polymer material, and a thickness of the polymer sheet is smaller than the thickness of the roll of polymer material, the thickness of the polymer sheet is smaller than an average pore diameter of the roll of polymer material, and a precision error of the continuous cutting step is within ±20%; and
a winding step, wherein the polymer sheet is wound into a roll of polymer sheet, at a winding tension of 0 N to 100 N.

8. The method according to claim 7, wherein the cutting device comprises one or more of a belt peeling machine, a hot wire cutting machine and a hacksaw cutting machine.

9. Use of the polymer sheet according to claim 1 as a sealing and cushioning material for electronic devices, the electronic devices comprising at least one of a smartphone, a liquid crystal display television, a tablet computer, a liquid crystal display screen, a battery, or a new energy vehicle.

10. The use of the polymer sheet according to claim 9 as a sealing and cushioning material for electronic devices, wherein the polymer sheet has an apparent density of 0.01 to 0.6 g/cm3.

11. The use of the polymer sheet according to claim 10 as a sealing and cushioning material for electronic devices, wherein the polymer sheet has a compression ratio of 50% to 95%.

12. The use of the polymer sheet according to claim 11 as a sealing and cushioning material for electronic devices, further comprising at least one of an adhesive layer or a functional layer, wherein the at least one of the adhesive layer or the functional layer is formed on a surface of a body of the polymer sheet.

13. The use of the polymer sheet according to claim 12 as a sealing and cushioning material for electronic devices, wherein the polymer sheet is obtained by cutting a base material in such a manner that the cut polymer sheet has a thickness smaller than an average pore diameter of the polymer sheet;
the polymer sheet has a thickness of 10 μm to 500 μm, and is in a form of honeycomb in a thickness direction, wherein the polymer sheet has, in structure, through-pores along the thickness direction, with a through-pore ratio of 20% to 60%.

14. The polymer sheet according to claim 2, wherein the polymer sheet has a compression ratio of 50% to 95%.

15. The polymer sheet according to claim 2, further comprising at least one of an adhesive layer or a functional layer, wherein the at least one of the adhesive layer or the functional layer is formed on a surface of a body of the polymer sheet.

16. The polymer sheet according to claim 3, further comprising at least one of an adhesive layer or a functional layer, wherein the at least one of the adhesive layer or the functional layer is formed on a surface of a body of the polymer sheet.
